(19) United States
(12) Patent Application Publication
(10) Pub. No.: US 2004/0128210 A1
(43) Pub. Date: Jul. 1, 2004

(54) Marketing information system for remote computing platforms

(75) Inventors: John S. Gabos, Minnetonka Beach, MN (US); Douglas A. Olson, Eden Prairie, MN (US); Kirk W. Dybvik, Chaska, MN (US)

Correspondence Address: MERCHANT & GOULD PC, P.O. BOX 2903, MINNEAPOLIS, MN, 55402-0903, US

(73) Assignee: Iceberg International, Inc., Minnetonka, MN

(21) Appl. No.: 10/731,939

(22) Filed: Dec. 9, 2003

Related U.S. Application Data
(63) Continuation of application No. 09/750,636, filed on Dec. 28, 2000, now abandoned.
(60) Provisional application No. 60/181,582, filed on Dec. 28, 1999.

(51) Int. Cl. G06F 17/60

(52) U.S. Cl. 705/26

(57) ABSTRACT

A computing system for managing shopping events at one or more retail locations is disclosed. The system comprises a hand-held computer configured to receive shopping list information from a user. The system also comprises a server computing system operable with the hand-held computer. The server computing system is configured to receive the shopping list information from the hand-held computer and distribute one or more information packets associated with each of the products comprising the shopping list to the hand-held computer in advance of a shopping event. The system further comprises a retailer computing system associated with each of the retail locations. The user can distribute the shopping list information and the information packets to the retail computing system as the user completes the shopping event.

### CLAIM TO PRIORITY UNDER 35 U.S.C. § 119(e)

Priority under 35 U.S.C. § 119(e) is claimed to provisional application serial No. 60/181,582, filed on Dec. 28, 1999, and entitled, “MARKETING INFORMATION SYSTEM FOR REMOTE COMPUTING PLATFORMS.” The complete disclosure of application 60/181,582 is incorporated by reference herein.

### TECHNICAL FIELD

The present invention relates to a computing system for managing information, and more particularly, to a computing system for managing and communicating information relating to products and/or services between a remote computing platform and a central computer.

### BACKGROUND

Companies are continually seeking ways to persuade consumers to purchase their products over the products of their competitors. Many companies expend large amounts of resources attempting to identify consumers who purchase the products of their competitors. The methods used to identify consumers who purchase a competing product vary, but are usually reliant on several factors. For example, in order to identify those consumers that may purchase a competing product, companies may utilize information relating to the consumer's past purchasing history or planned purchase events.

Similarly, companies expend substantial resources to persuade consumers to purchase their products. The methods used by companies to persuade consumers to purchase their products depend on a variety of factors, such as the proximity between the delivery of the marketing message and when the consumer makes his/her purchase. For example, some people believe that the closer a marketing message can be delivered to the time the consumer plans to make a purchase, the greater the probability for a successful outcome for a company making the offer.

Moreover, businesses have always looked for ways to provide more service to their customers in order to increase market share and customer satisfaction. As new technologies are developed, businesses endeavor for ways to adopt these technologies in order to achieve operational efficiencies or to deliver additional services to their customers. For example, some companies are presently utilizing the Internet to market their products and/or services directly to the consumer. Alternatively, some companies offer promotional programs that reward consumers by offering discounts for repeat visits or purchases.

However, existing systems that utilize these methods have several shortcomings. For example, many existing systems focus on historical events such as the consumer's past purchasing history or planned purchase events in order to influence the consumer's purchasing decision. Alternatively, other existing systems provide marketing information to consumers after they make their purchases. For example, these systems provide marketing information to the consumer at the point of sale in the retail environment or as a follow-up communication through the mail or some other form of communication. As a result, these systems are unable to provide effective marketing information to the consumer based upon the consumer's expressed intentions. Still yet, once an organization commits to a marketing approach, it often difficult for the organization to measure the effectiveness of their promotional efforts once the consumer has completed his/her shopping experience.

Furthermore, these systems are also limited to providing marketing information to the consumer before the user enters the retail store without regard to the consumer's intentions as they enter the retail store. Additionally, many existing systems are unable to provide the consumer with a single integrated source for managing information relating to products and services. As a result, consumers have to rely on information from several sources. Furthermore, the consumers typically have to analyze and compare the information relating to the products or services they are interested in manually.

### SUMMARY

In general terms, the present invention relates to a computing system for managing information. In one aspect, the invention relates to a computing system for managing and communicating information relating to products and/or services between a remote computing platform and a central computer. The computing system comprises a server application in communication with a client application residing on a remote computing platform. The server application distributes promotions and other marketing information to the client application and measures the effectiveness of the promotional and marketing activities in modifying the purchasing decisions of the consumer.

The computing system relates to a closed loop marketing system (“CLMS”) that comprises a server application in communication with retail store applications. The system is built around the consumer managing a shopping list and interfacing that list of planned purchases with retailer's computing system just prior to beginning a shopping trip. This system allows the retailer to deliver promotions and services to the customer just prior to and during the shopping trip. Accordingly, the computing system is able to deliver meaningful information to the consumer at a time just prior to and during the shopping trip. This information is provided and to measure the effectiveness of these promotions and services upon the customer's completion of the shopping trip.

Additionally, the server application maintains a user profile and information on participating retailers and suppliers. Portions of the server application may be accessed by the consumer user over a network allowing the user to enter and modify data that pertains to their specific shopping needs, intentions and interests. Portions of the server application are operations performed by the CLMS application.

In one aspect, the user can maintain and modify a shopping list on the CLMS server using a hand-held computing device. This hand-held computing device can be owned by the consumer. Alternatively, the hand-held computing device can be provided to the consumer by an outside service or retailer utilizing the CLMS application. The hand-held computing device can be equipped with a barcode scanner that can be used to scan universal product codes (“UPC”) on the products the user wished to add to their shopping list. Alternatively, the consumer can manually enter the product's UPC, name, or other identification into the hand-held computing device. The consumer application residing on a hand-held computer is capable of interfacing to a variety of different retail store systems through the CLMS server. Accordingly, each different retailer will not require a separate and unique shopping list application.

In another aspect, the server application collects information from the client application and from the retail store system. The CLMS system processes that information and delivers a refined shopping list back to the user. For example, the refined shopping list can include products not originally on the user's shopping list but which are products they commonly purchase at the selected retailer, products not originally on the user's shopping list but which are items they occasionally purchase at the selected retailer and which might need to be replenished, new products to the store that may fit the consumer user's profile, promotional offers based on products on their planned shopping list or the consumer user purchase history.

In yet another aspect, the original or refined shopping list can be printed so that the consumer can carry the list with them while shopping. Alternatively, the information may be delivered to the consumer's hand-held computing device for use during the shopping trip.

In one aspect, the promotions can be coupons redeemable for a portion of the purchase price. The promotions can also be in the form of bonus points in the retailer's or other loyalty program. Other types of promotions can be offered and customized based on the retailer, consumer or other third-party utilizing the CLMS. Additionally, the appearance of the shopping list may be modified according to retailer or the consumer. For example, the shopping list can be customized by the consumer by sorting the products on the list according to the most efficient route for selecting the products while shopping. Furthermore, different fonts, colors and print sizes can be used to indicate the significance of the information being displayed to the consumer.

In another aspect, the consumer can communicate their shopping list to the CLMS server via a hand-held computing device. The CLMS server can return a shopping list to the consumer's hand-held computing device. The consumer can identify themselves to the CLMS server while completing the shopping trip at the retailer's point-of-sale (“POS”) check out. The CLMS server working in conjunction with the POS system can track all of the items purchased by the consumer during the shopping trip. The CLMS server can also compare the actual products purchased with the list identified by the consumer user immediately preceding the shopping trip to determine the effectiveness of the promotions offered to the consumer prior to and during the shopping trip. The results of this comparison can be communicated to the applicable retailer and supplier business partners to assist in measuring the effectiveness of the marketing and/or promotional offerings made to the consumer. Similarly, the consumer can purchase products that were forgotten by reviewing or printing the comparison list to determine the items on the shopping list but were not purchased.

In another aspect, the hand-held computing device can be equipped with a barcode scanner. Accordingly, when the consumer is using the hand-held computing device to manage the shopping list while shopping, the consumer can scan the UPC barcode on the products as they are placed into the shopping cart. Furthermore, the consumer can use connection points within the retail store that allow the consumer's hand-held computing device to access the CLMS server and measure the progress of their shopping trip (i.e. determine what items are left to purchase). Alternatively, if the consumer's hand-held computing device is capable of communicating wirelessly, the shopping list can be updated and managed in real-time. In so doing, the consumer is allowed to manage and send or receive information relating to products and/or services between his/her remote computing device and a central computer in real-time.

Another aspect relates to a distributed computing system having a server computing system in communication with a client computing system. The server computing system comprises an CLMS server application. The client computing system comprises an CLMS client application residing on a hand-held computer. The client computing system communicates with the server computing system through a communications network, for example, the Internet or via a direct connection in a retail store.

The hand-held computing device is a palm-sized computer such as the Palm Pilot® from Palm Computing. However, other palm-sized computers and operating systems can be used. For example, the CLMS client application can operate with Windows CE® operating system devices, Tablet PC (personal computer) devices, lap top personal computers, desk top personal computers or cellular phones. In addition to the CLMS client application, the hand-held computer may have other software applications installed on it for managing information. For example, web applications such as web browsers can be installed on the hand-held computer. Similarly, business applications, personal information management (“PIM”) applications can be installed on the hand-held computer.

In another aspect of the invention, the CLMS server application distributes information to the CLMS client application. The information distributed by the CLMS server application can include appointments, advertisements, promotional offers, business application code, CLMS application code, application data, pictures, diagrams or other graphical data. The CLMS client application may integrate the information into existing applications residing on the hand-held computer. For example, the CLMS client application can integrate the information directly into PIM applications such as a date book application, a calendar application, an address book application, task list applications, memo pad applications, or email applications. Similarly, the CLMS client application can integrate the information directly into non-CLMS business applications or separate CLMS information management applications resident on the hand-held computer. An information system having these features is the subject of currently pending U.S. Nonprovisional patent application entitled “INFORMATION MANAGEMENT SYSTEM FOR REMOTE COMPUTING PLATFORMS” to Gabos et. al, filed Sep. 19, 2000, and assigned Ser. No. 09/664,805, the entire disclosure of which is herein incorporated by reference.

In another aspect of the invention, the CLMS server application generates the information that will be distributed to the CLMS client application. Alternatively, the CLMS server application receives the information from a third-party server application. In either case, the CLMS server application distributes the information to CLMS client application on the user's hand-held computer. The CLMS client application integrates the information directly into existing applications residing on the hand-held computer.

In another aspect of the invention, the CLMS server application can automatically select and deliver information based upon a user's needs. The CLMS server application catalogs the user's needs as entries in a profile management database. The profile management database contains information specific to each user as well as information relating to the services requested or business applications operating on the user's hand-held computer. For example, the profile management database can store a unique user identification number, user name and password along with additional optional security features, group associations, interests, preferences, PIM information, and CLMS application history data. The user profile information can be provided when the user initially accesses the CLMS computing system.

Alternatively, user profile information can be provided either at the request of the user or the CLMS computing system. The profile management database can be the basis for promotions and services that are generated and delivered to the user. The CLMS server application will generate or receive the applicable information packets and distribute them to the CLMS client application according to the services or applications specific to each user or group of users.

In yet another aspect of the invention, the CLMS client application integrates the information distributed by the CLMS server application directly into a non-PIM application resident on the hand-held computer. While operating the non-PIM application, the user can access and/or modify the information. Additionally, the user can manually integrate the information into a PIM application.

### BRIEF DESCRIPTION OF THE DRAWINGS

FIGS. 1A and 1B illustrate a computing system for delivering promotions to a remote computing platform;

FIG. 2A illustrates an overview of the logical operations of the various embodiments of the CLMS application;

FIGS. 2B-D illustrates the logical operation of the various embodiments of the CLMS application;

FIGS. 3-7 and 10-13 are sample screen shots showing a hand-held computing device 34 or 35 that would be used in a CLMS shopping list application including the various features provided by the CLMS application; and

FIGS. 8 and 9 are sample shopping lists that can be printed in the retail store immediately prior to the consumer user beginning a shopping trip.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto.

The following discussion provides a description of a suitable computing environment in which the invention may be implemented. Despite the specific description, the claimed invention may be practiced with many computer system configurations such as hand-held computers or devices (“HHCs”), laptop computers, desktop computers, and network PCs.

The embodiments of the present invention are implemented as logical operations in a distributed processing system having client and server computing systems. The logical operations of the present invention are implemented (1) as a sequence of computer implemented steps running on the computing system; and (2) as interconnected machine modules within the computing system. The implementation is a matter of choice dependant on the performance requirements of the computing system implementing the invention and the components selected by or utilized by the users of the system. Accordingly, the logical operations making up the embodiment of the invention described herein are referred to variously as operations, steps, or modules.

Furthermore, because of the variety of the devices that could be used as to implement the invention, the user interface will vary and will be optimized for the device being used. For example, buttons, checkboxes, hyperlinks may be interchanged or substituted depending on the operating system and device.

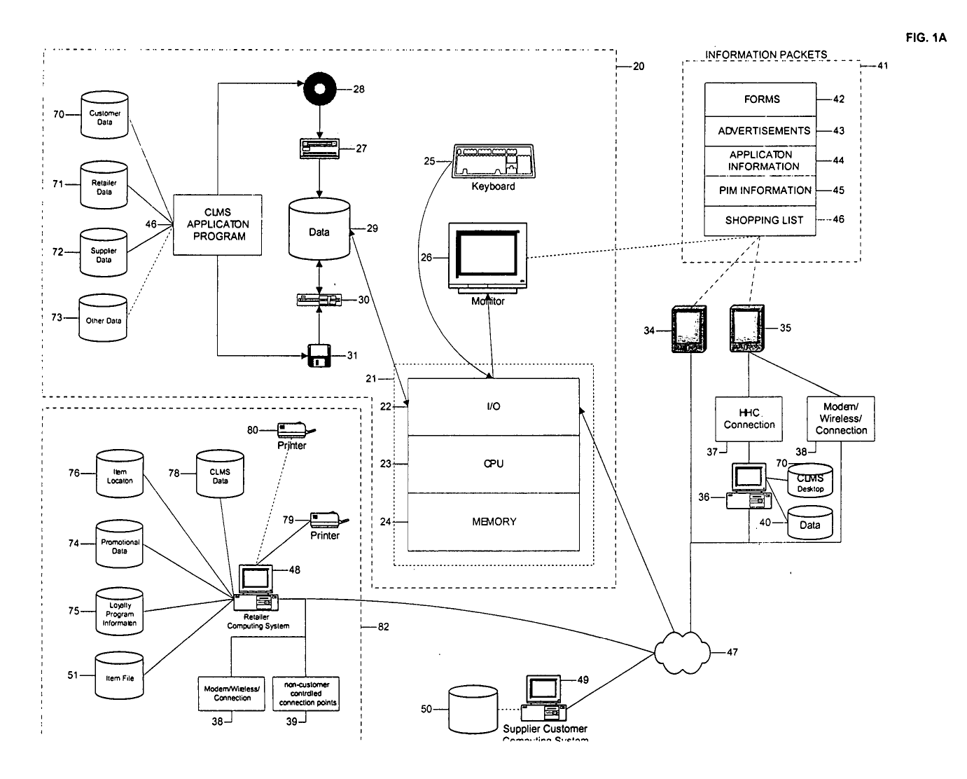

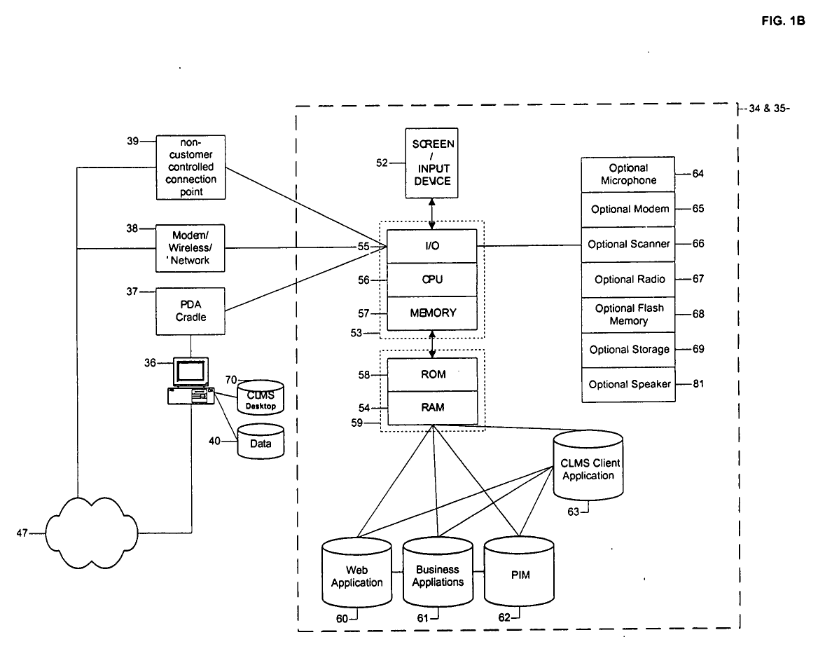

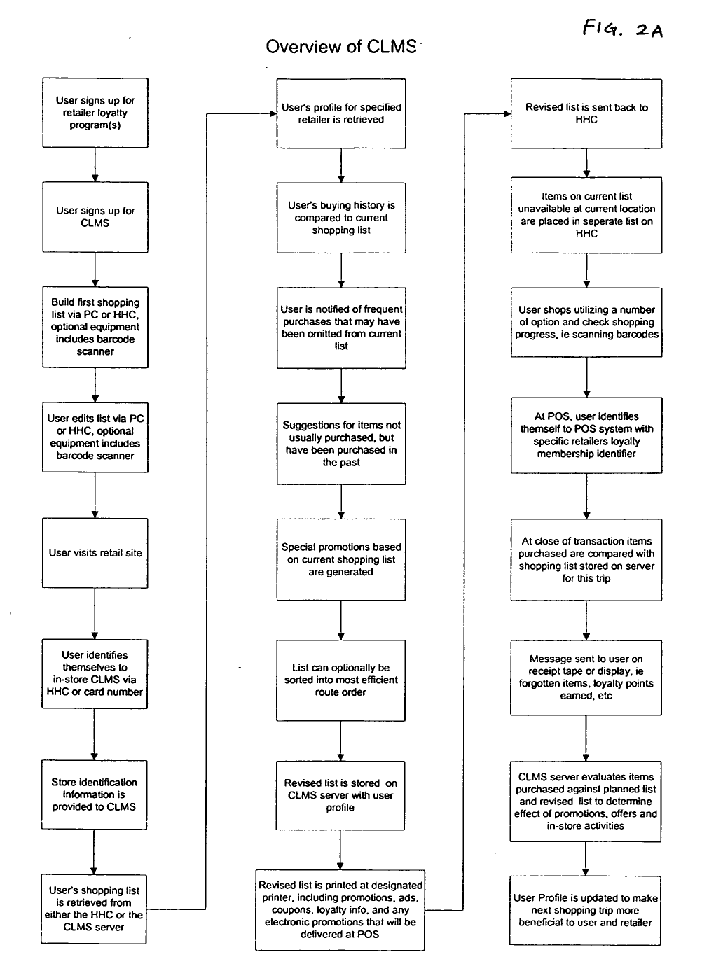

Referring now to FIG. 1A, CLMS application server 20 includes application program 46 and processor 21. Application program 46 is loaded onto CLMS application server 20 from a CD-ROM 28, diskette 31, or other suitable storage device. Additionally, application program 46 accesses various sources of application data when processing a transaction. For example, application program 46 can access customer data 70, retailer data 71, supplier data 72 as well as other miscellaneous data 73. The application data can be created by the CLMS application server 20 or it can be provided to the CLMS application server 20 from external sources. For example, the application data can be provided to the CLMS application server 20 by an external retailer computing system 82 or a supplier customer computing system 49.

Retailer computing system 82 communicates with CLMS application server 20 via communications network 47. Retailer computing system 82 may contain information that includes, but is not limited to, an item file 51, item location information 76, promotional information 74, loyalty program information 75 as well as CLMS application data 78. Item file 51 contains information relating to the product offered at the various retail stores, for example, product information, unit price, and other similar information. Item location information 76 defines the approximate location where a particular item may be found within the retail store. Promotional information 74 relates to promotions that may be available to customers that are eligible for the promotional offerings. Loyalty program information 75 defines that information relevant to each retailer's loyalty program. CLMS application data 78 includes, but is not limited to username and identification number, user profile information, CLMS user history, as well as statistics and/or results. Additionally, CLMS application data 78 can include a larger repository of data that includes an item file 51, item location information 76, promotional information 74, or loyalty program information 75.

Retailer computing system 82 may also provide connection points that allow users to communicate and interface with the CLMS application server 20. For example, as shown in FIG. 1A, retail computing system 48 may allow a customer to access the CLMS application server 20 using a hand-held computer with a modem, radio, wireless, or other modes of communication. Alternatively, retailer computing system 82 may allow a customer to access the CLMS application server 20 using non-customer controlled connection points 39.

CLMS application server 20 may operate on any computing system running a supported operating system. For example, CLMS application server 20 may operate on any computing system capable of functioning as a computing server. For example, CLMS application server 20 can be a desktop personal computer, a laptop personal computer or other similar mobile computers. Examples of supported operating systems include, but are not limited to, those sold under the brand names Microsoft Windows™, Unix™, Linux™, DOS™, AIX™ and other similar operating systems.

Processor 21 of CLMS application server 20 includes an input/output section 22, a central processing unit 23, and a memory section 24. Input/output section 22 may be connected to various peripherals to accept input from a user or display output to a user. For example, input/output section 22 may be connected to a keyboard 25 to receive input from a user. Similarly, input/output section 22 may be connected to a monitor 26 that can be used to enter or display information to a user. A disk storage unit 29 capable of reading a diskette 31 through disk drive unit 30 may also be configured to operate with input/output section 22. Likewise, an optical disk drive unit 27 capable of reading a CD-ROM 28 may be configured to operate with input/output section 22 or other similar storage devices.

In addition to the peripheral devices identified above, input/output section 22 contains a communications adapter (not shown) to enable communications across network 47. In one embodiment, network 47 is the Internet. Alternatively, network 47 can be a LAN, WAN or any other network that can transfer data. However, in an alternative embodiment, it is possible for users to connect directly to the CLMS application server 20 using a wide variety of network communications, such as a direct dial-up connection. Furthermore, another embodiment allows users to connect to more than one CLMS application server 20 during operation.

CLMS application server 20 is capable of communicating with a remote computing platform. In one embodiment, the remote computing platform is a hand-held computer 34 or 35. Hand-held computers 34 and 35 are generally considered remote computing systems that contain computing equipment and applications as will be further discussed below. In one embodiment, hand-held computer 34 or 35 could be a palm-sized computer from Palm Computing. However, it should be understood that other computing devices might also be considered hand-held computing devices. Examples of such devices might include, but are not limited to, those sold under the brand names Palm™ operating system devices, Windows CE™ operating system devices, Tablet PC™ devices, laptop personal computers, desktop personal computers, cellular phones and/or electronic paging devices.

Hand-held computers 34 and 35 are capable of connecting to network 47 in a variety of ways. For example, in one embodiment, hand-held computer 34 is wireless and connects to network 47 using an internal modem or radio (not shown). Alternative methods for connecting a hand-held computer to network 47. For example, hand-held computer 35 can connect to network 47 through cradle 37 and 39 that is hardwired to a personal computer 36. In this case, the connection between hand-held computer 35 and cradle 37 and 39 can be accommodated using a variety of modes of connection, including infrared, radio frequency, physical connections or other modes supported by the applicable connection points and hand-held computing devices. Similarly, hand-held computer 35 can be connected to network 47 using a wireless, modem or radio enabled connection device 38.

In one embodiment, a consumer can manage a shopping list by accessing CLMS server application 20 through an available primary connection point. Primary connection points available to the consumer can be located at any appropriate place, for example, at the consumer's home or work location. In another embodiment, however, the consumer may still access the CLMS application server 20 despite not being at a primary connection point. Accordingly, the consumer may access CLMS application server 20 via non-customer controlled connection points 39. Non-customer controlled connection points 39 would be located in places where users visit away from their primary connection points. For example, non-customer controlled connection points 39 can be located in retail stores, schools, hospitals, post offices, sports stadiums, banks, airports, restaurants, hotels, athletic clubs, and various other locations.

At the user's request, CLMS application server 20 places information 41 on a user's hand-held computing device 34 or 35 through network 47. Information 41 can include forms 42, advertisements 43, CLMS application information 44, and PIM information 45. In one embodiment, information 41 is produced by application program 46 on CLMS application server 20. Alternatively, information 41 can be automatically be forwarded to CLMS application server 20 from retailer computing system 82 or a supplier computing system 49. Moreover, CLMS application server 20 can optionally deliver information 41 directly to disk storage area 40 of personal computer 36.

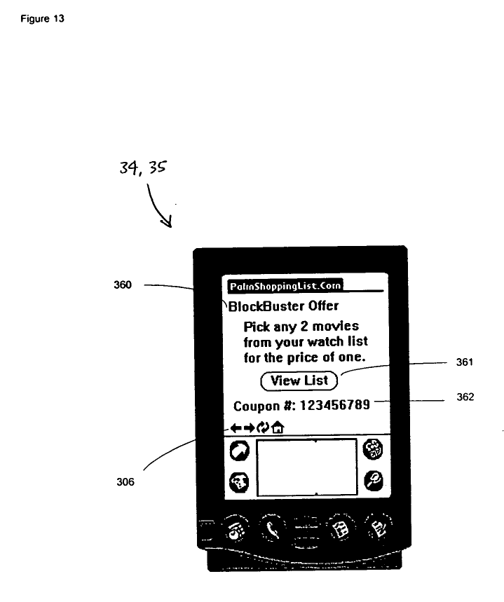

Information 41 may contain a promotional offer redeemable by the user at participating retailers or other businesses. In one embodiment, the promotional offer may contain a unique identifier number that can be used for different purposes. For example, the unique identifier may be used to indicate the authenticity of the promotional offer. Similarly, the unique identifier can be used to verify whether the promotional offer has been redeemed as well as to update the consumer, supplier and/or other promotional records. (See FIG. 13).

When redeeming a promotional offer, the user can communicate the unique identifier to the retailer who can enter the unique identifier into the POS system or remote connection point 39. For example, the consumer can verbally communicate the unique identifier to the retailer. Conversely, the consumer can show the promotional offer to the retailer as it is displayed on the display 52 of hand-held computing device 34 or 35. The promotional offer can be displayed with a corresponding barcode that the retailer can scan into the POS system or remote connection point. Alternatively, the consumer can transmit the information via infrared, radio frequency or a physical electronic connection to the POS system or remote connection point.

In another embodiment of the invention, the HHC is connected wirelessly to the CLMS server and the unique identifier is transmitted to the CLMS server without being transferred first to the POS system. The retail associate can communicate to the consumer a unique retail code or store number that would be communicated back to the CLMS server to track the promotional offer.

In so doing, either the POS system or remote connection point is capable of connecting to the CLMS application server to confirm and track promotional offer. In one embodiment, the CLMS server can communicate an authorization code for the promotion back to the retailer. Furthermore, the CLMS server can track and compensate the applicable parties. It should be noted that the consumer's participation in the CLMS system can be tracked and additional promotional offers including, but not limited to rebates can be delivered to the user based on their level and types of participation.

Forms 42 display information to the user and allow the user to input data into hand-held device 34 or 35. In one embodiment, forms 42 may include a form allowing the consumer to add or delete entries from a shopping list. Similarly, forms 42 might also include a form allowing consumers to request additional information related to a selected product. Forms 42 may also allow the consumer to request to purchase the product or service or enter an inquiry seeking additional information. If the consumer completes an available form 42, the completed form is returned to CLMS application server 20 for additional processing to complete the consumer's request. Alternatively, completed forms 42 may be delivered to either supplier computing system 49 or retailer computing system 82 for additional processing to complete the consumer's request.

Advertisements 43 provide information to the user regarding a supplier's goods or services. Accordingly, the user can request that more information be provided about the particular good or service described in advertisement 43. In the event the user has selected that more information be provided about the goods or services described in advertisement 43, this request will be stored in the storage area of hand-held computer 34 or 35.

CLMS application server 20 may be resident on a computing network operated by a retailer that provides the CLMS system to consumers. In this instance, CLMS application server 20 may be located in the retail store or at an other central location allowing all of the retail stores to be configured in a network. Thus, administration and performance of the CLMS system may be split between multiple CLMS servers located at various locations in the retailer's organization and accessible via communications network 47. Alternatively, the retailers can subscribe to a third-party service that administers the CLMS application for numerous retailers.

Referring now to FIG. 1B, CLMS application client 63 is installed on hand-held computer 34. PIM applications 62 may optionally be installed on hand-held computer 34. Examples of PIM application include calendar, date book, address book, to do list, or memo pad applications.

In FIG. 1B, hand-held computer 34 includes a screen input device 52, processor 53, and a memory section 59. Processor 53 is comprised of an input/output section 55, a central processing unit 56 and memory 57. Input/output section 55 is configured to operate with screen 52. In one embodiment, screen 52 functions as an input device. Furthermore, input/output section 55 can have many other optional input/output devices, components or modules. For example, input/output section 55 can be configured to operate with a microphone 64, a modem 65, a barcode scanner 66, an optical scanner or other type of automatic identification or information reading device, a radio 67 for communications, flash memory 68 for additional information storage, an additional storage area 69 or optional speaker 81.

Memory section 59 is comprised of read only memory (“ROM”) 58 and random access memory (“RAM”) 54. In one embodiment, memory section 59 can store web applications 60, business applications 61, PIM applications 62, and CLMS application client 63. An example of a web application 60 would include a web browser. Business applications 61 stored in memory section 59 might include inventory, sales order, field tracking, or other comparable business applications according to the user's needs. Similarly, PIM applications 62 might include calendar, address book, to do list, memo, e-mail, or other comparable PIM applications. Furthermore, memory section 59 can store product UPC barcodes and product information. Product barcode information can be selectively stored based upon the consumer's purchasing history. Moreover, if the hand-held computer 34 or 35 is communicating wirelessly across network 47, the consumer can access UPC barcode and product information from retailer computing system 82.

In one embodiment, CLMS application client 63 allows the user to create or edit data while not connected to the CLMS application server 20. For example, a user may select to edit information 41 that was transferred to hand-held computer 34 or 35 from CLMS application server 20. CLMS client application 63 stores information packets and queues the information to be returned to CLMS server application 20 the next time the user connects to CLMS application server 20. For example, where information 41 is a form 42, such as a marketing survey, the user can access form 42 using CLMS client application 63 or some other business application while not connected to the CLMS server computing system. Form 42 will automatically be returned to CLMS application server 20 upon the user's next connection to network 47. Furthermore, a confirmation of this transaction can be returned to the user as soon CLMS server application 20 completes the transaction.

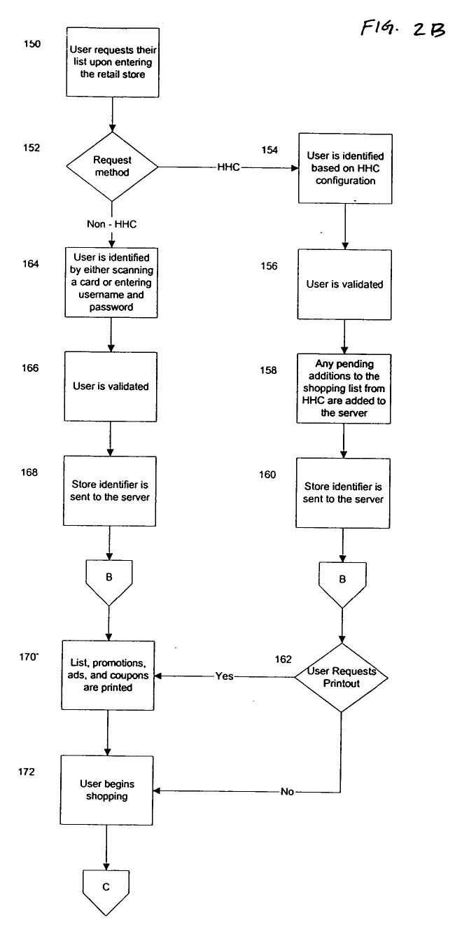

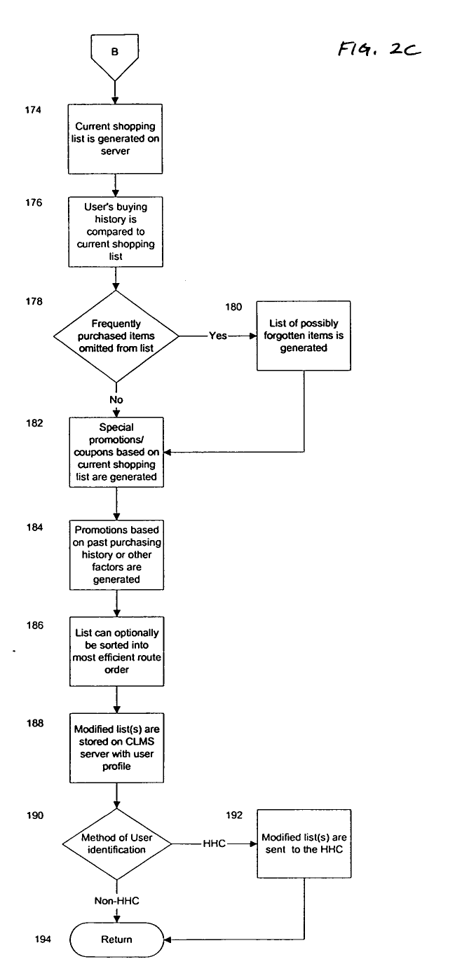

FIG. 2A illustrates an overview of the logical operations of the various embodiments of the CLMS application. The logical operations of the system for delivering promotions to a remote computing environment are shown in more detail in FIGS. 2B-D. Although each step is documented in a sequence, it should be understood that logical operations of the system can occur in other sequences. Furthermore, some of the items may or may not have already been generated by CLMS application server 20 and passed down to CLMS application client 63 at the time the hand-held computer 34 or 35 is synchronized with CLMS application server 20. For example, the flowchart may call for the CLMS application server 20 to generate a page that already exists on the hand-held device. In these situations, CLMS application client 63 will first check memory section 59 for an existing page. Additionally, the CLMS application client 63 may also check any available optional storage areas 69. If the CLMS application client 63 locates the requested page in either memory section 59 or optional storage area 69, the stored page is displayed to the user.

If hand-held computer 34 or 35 is attached to communications network 47 and is in communication with CLMS application server 20, the server may not initiate processing at the time of the request. For example, if CLMS application server 20 is waiting on information from an external source, the server may not initiate processing at the time of the request. Moreover, when CLMS application client 63 generates orders or requests and CLMS application server 20 is not available (i.e. not presently in communication with CLMS application server 20), these requests will be queued on hand-held computer 34 or 35 and passed to CLMS application server 20 upon the user's next connection to the network.

In one embodiment, there are several features of the present system that are configurable and/or optional to retailers that use the system. For example, retailers that use the system may store product and consumer information relating to their existing loyalty programs. Likewise, there are features that are configurable and/or optional to consumers that use the system. For example, a consumer might register with the CLMS system before accessing the system. In such cases, the consumer can enter profile information that includes, but is not limited to, the names of retailer loyalty programs with which the user is associated as well as information relating to the consumer's willingness to disclose this or similar information. In addition to being registered with the CLMS system, consumers may also be registered in a retailer's loyalty programs.

If the consumer is registered in the CLMS system, they can build a master or default shopping list associated with each retail organization using the CLMS system. Thus, a consumer can utilize separate shopping lists for a variety of different retail organizations. The master shopping list can be created from scratch by the consumer, compiled from the consumer user's purchasing history or automatically created according to a specified list. For example, the products on the shopping list can be automatically added to the shopping list according to a recipe on the consumer's hand-held computing device. Thus, the consumer can select the recipe so that the required ingredients are automatically added to the consumer's shopping list 46. The default shopping list can be created for each retail store according to the consumer's profile information. For example, the default shopping list can include items commonly purchased at the retail store along with any additions or deletions that the consumer has made to his/her profile.

In one embodiment, the user can access CLMS application server 20 by using an Internet browser or communication applications resident on hand-held computing device 34 or 35. Upon connection to CLMS application server 20, the available information 41 can be delivered to and received from hand-held computing device 34 or 35.

CLMS application client 63 begins when a consumer enters a participating retail store and initiates a connection with the CLMS application server 150. In one embodiment, the initiation of a connection occurs when the consumer requests to synchronize his/her hand-held computer 152. If the consumer is accessing CLMS application server 20 using a hand-held computing device, the system identifies the consumer using information obtained from the hand-held computing device. For example, CLMS application server 20 can identify the consumer based on the configuration of the hand-held computing device 154. After the consumer has been identified, CLMS application server 20 validates the user 156. Any pending changes to the consumer's shopping list are received from the hand-held computing device 34 or 35 and integrated into customer data 70.

Moreover, in another embodiment, each of the retail stores has a unique identifier associated with the retail store stored on CLMS application server 20. If a store identifier accompanies the consumer identification and/or validation process 160, CLMS application server 20 can determine that the consumer is connecting from a retail store and is beginning a shopping event.

In an alternative embodiment, a consumer may access CLMS application server 20 without using a hand-held computing device. In such cases, the consumer may identify themselves using an identification card having a barcode, magnetic strip, smart card or some other similar device 164. Alternatively, the consumer can enter their username and password 164. In either case, CLMS application server 20 will validate the consumer after they have been identified 166. Moreover, if a store identifier accompanies the consumer identification and/or validation process 168, CLMS application server 20 can determine that the consumer is connecting from a retail store and is beginning a shopping event.

When CLMS application server 20 detects a store identifier 160 or 168, a current shopping list 46 is generated 174. For example, shopping list 46 can be generated using products that the consumer has previously purchased from the particular retailer. At this point, shopping list 46 is optimized for the consumer's shopping trip at the specific location where they are connected. For example, shopping list 46 can include products that the consumer needs to replace because the anticipated time to replenish has expired. CLMS application server 20 can organize the list around those items that the consumer wants or needs. Alternatively, CLMS application server 20 can produce a shopping list 46 organized according the items that the consumer typically prefers to purchase from the current retail location or the list can include all the items the consumer wants and needs irrespective of the retailer. For example, the consumer can specify that he/she wants to purchase certain products, such as produce or meat products, only from certain retailers. Alternatively, the consumer can specify that the products can be purchased at any retail location. These options can be selected jointly or independently by the consumer, the retailer and the CLMS system administrator.

In one embodiment, the generated shopping list can be compared to the consumer's purchasing history 176. For example, the generated shopping list can be compared to the consumer's purchasing history for a specific retailer. Alternatively, the generated shopping list can be compared to the consumer's purchasing history for all retailers using the CLMS system. Additionally, those items that are frequently purchased by the consumer, but are not on the generated shopping list may be added to the shopping list 178. Similarly, those items that have a scheduled or anticipated time for replacement or replenishment can also be added to the shopping list 180. The items added to the list may be displayed to the user in a special color, font or other similar display characteristics such that the consumer can distinguish the items added from those already on the list.

In yet another embodiment, the CLMS system can deliver special promotions and marketing information to the consumer's hand-held computing device according to the consumer's shopping list 182. These special promotions and marketing information can be in the form of promotional offers, coupons, or other similar information that can be delivered to the hand-held computing device, retailer's POS system or printed. Alternatively, these special promotions and marketing information can be delivered to the consumer according to established criteria found in the consumer's profile 184. For example, special promotions and marketing information can be delivered according to the consumer's purchase history.

An additional feature of the CLMS system would allow the items in the consumer's list to be organized according to the order the consumer will encounter them in the retail store environment 186. In so doing, the shopping list generated by the CLMS system will allow the user to easily and efficiently progress throughout the store while shopping. For example, the shopping list can be organized according to specific retail store information such as aisle number and/or shelf location.

Any modifications the consumer makes to the generated shopping list 46 will be saved on CLMS application server 188. For example, the consumer can select from his/her hand-held computing device to save the modified list on the CLMS application server. Additionally, the consumer's shopping list may also be stored on the retailer's computing system while the consumer is shopping in the store. For example, Alternatively, the consumer's shopping list may be downloaded from the CLMS system to the retailer's shopping list at a time other than when the consumer in shopping. For example, the retailer may request to download the shopping lists of consumers meeting a certain profile or the retailer may schedule periodic batch downloads of the shopping lists for all of the consumers that shop in their store.

In one embodiment, the shopping list 46 automatically generated by CLMS application server 20 can be delivered to the consumer's hand-held computing device for use during the shopping trip 192. Alternatively, the shopping list can be printed by the consumer 170 in the retail store or the shopping list can be downloaded and printed outside of the retail store. For example, the consumer can access the CLMS system from home and print the shopping list prior to commencing their shopping trip.

In addition to the shopping list discussed above, CLMS application client 63 can provide several options to the consumer while shopping in the retail store 196. For example, the consumer's hand-held computing device can be optionally equipped with a barcode scanner. In such a case, the consumer can scan the barcodes on items as they are placed in a shopping cart or bag. Accordingly, CLMS application client can manage the consumer's shopping list by identifying those items not yet placed in the shopping cart. Alternatively, the consumer can check the products off of the list as they are shopping. The CLMS application client can also display a running price total to the user by cross-referencing the product's price from the retailer's computing system or from a price table maintained on the CLMS application.

After gathering the items on the shopping list in the retail store, the consumer can purchase the items at the retailer's POS check-out system 198. The consumer can identify themselves at the retailer's POS system. The retailer's POS system can notify the CLMS system of the consumer's purchases 200. Accordingly, CLMS application server 20 can compare the items purchased to the consumer's shopping list 202. Moreover, CLMS application server 20 can also evaluate the effectiveness of the special promotions and marketing information delivered to the consumer 204. In another embodiment, the use of hand-held computing device 34 or 35 may be incorporated into a self-checkout option offered by the retailer.

After completing the shopping trip, the consumer's profile on CLMS application server 20 is updated 206. If there were items on the shopping list that the consumer did not purchase during the shopping trip, the system can generate a list of those items 210. Similarly, the system can generate a list of those items that the consumer purchased that were not on the list. In one embodiment, this list can be printed on the consumer's receipt or displayed on the consumer's hand-held computing device while they are in the retailer's POS check-out.

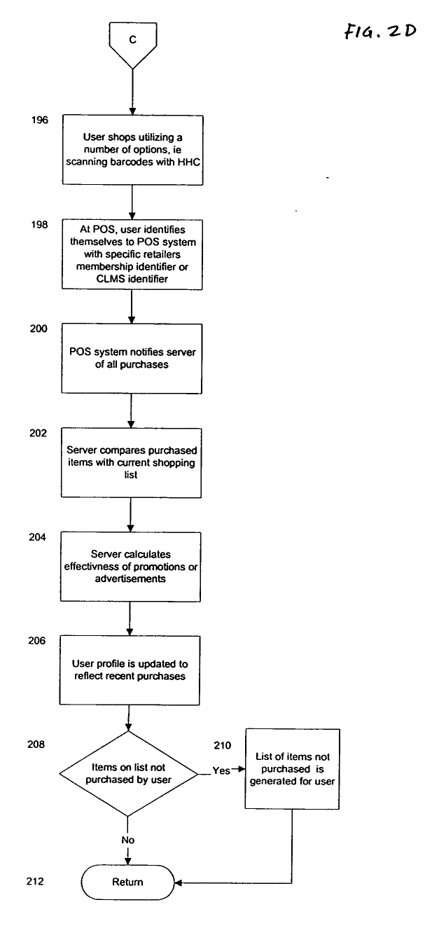

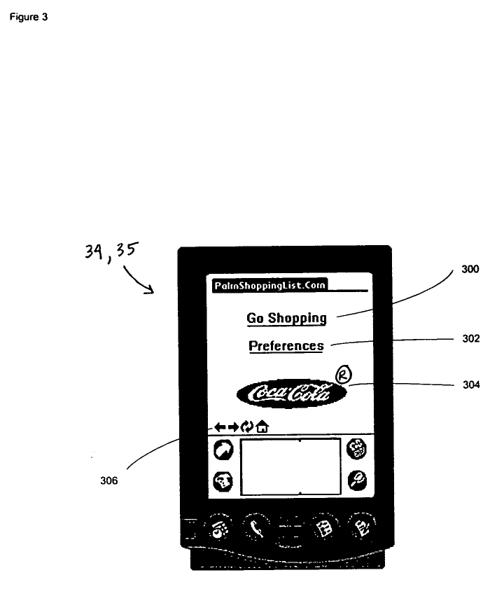

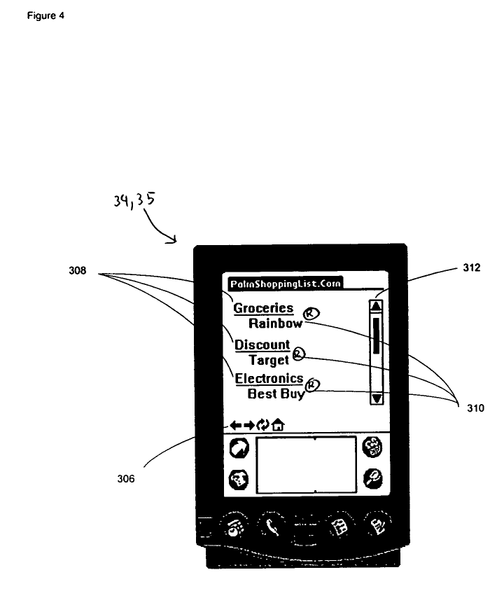

FIG. 3 is a sample screen showing a hand-held computer 34 or 35 using a shopping list application in accordance with the CLMS application. Item 300 is a graphical user interface (“GUI”) that represents a description of the area of the application that will be entered when the item 300 is activated. For example, in this case, go shopping GUI 300 begins a shopping experience or allows the consumer to enter information related to a shopping experience (See FIG. 5). GUI item 302 allows the consumer to launch into an area of the shopping application where the consumer would manage his/her settings or preferences within the CLMS application (See FIG. 4). GUI item 304 represents an vendor/supplier advertisement that may be sent down to the hand-held computing device 34 or 35.

Moreover, GUI item 306 allows the consumer to navigate through the various screens of the CLMS application client. For example, GUI item 306 can represent a browser bar that would be available to the consumer user. The specific buttons and options available to the consumer user would vary according to the browser chosen by the user for their hand held computing device 34 or 35.

In one embodiment, hand-held computing device 34 or 35 is equipped with a barcode scanner 66. Once the CLMS client application is opened as shown in FIG. 3, the consumer user can activate the barcode scanner and scan the product's barcode of an item that the user wishes to add to a shopping list.

FIG. 4 is a sample screen showing a hand-computer 34 or 35 using a shopping list application in accordance with the CLMS application that allows the consumer user to manage their system preferences. GUI items 308 describe the categories or the type of retailer that a user can select to edit the retailers or other types of vendors the user plans on using in conjunction with the CLMS application. For example, GUI item 308 can describe grocery, discount or electronics retailers. GUI item 310 represents the name of the retailer or vendor available under each of the categories or types of retailers discussed above. Furthermore, other hierarchical structures are possible. GUI item 312 represents a navigation element that allows the user to navigate through the information presented on the hand-held computing device's screen. For example, GUI item 312 can be a scroll bar allowing the user to view more items that are available but do not fit onto the screen.

FIG. 5 is a sample screen shot showing a hand-held computing device 34 or 35 that would be used in the CLMS shopping list application allowing the user to manage shopping the shopping list. For example, GUI item 316 allows the consumer user to edit shopping list items. Alternatively, GUI item 320 allows the consumer user to add shopping items to an existing shopping list. GUI item 318 allows the consumer user to commence a shopping event upon arriving at a retailer by communicating with the retailer's computing system 82. A consumer user can add advertised GUI item 322 to a shopping list by selecting GUI item 322. It should be noted that the consumer may manage his/her shopping list using any remote computing platform that can access the CLMS system, such as desktop computer 36.

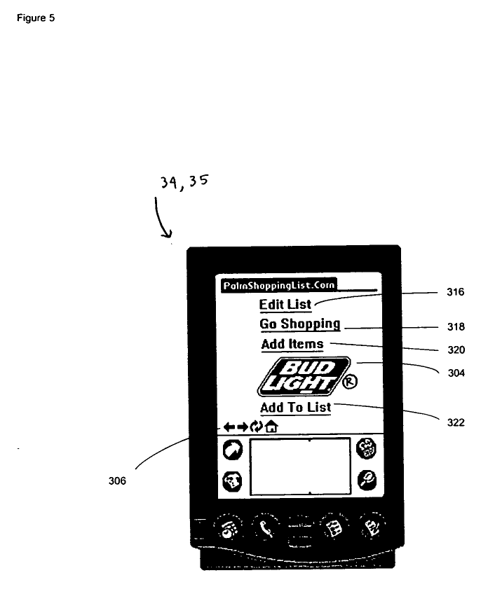

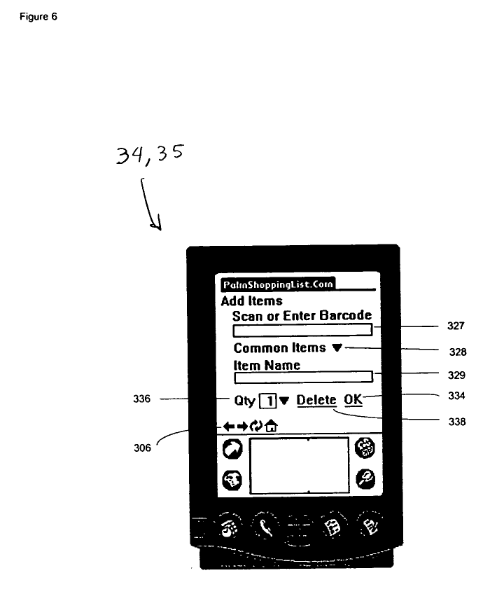

FIG. 6 is a sample screen shot showing a hand-held computing device 34 or 35 that would be used in a CLMS shopping list application further allowing the user to add items to a shopping list. GUI item 327 represents a data field area where the user can enter the product information. For example, GUI item 327 can allow the user to scan the product's UPC code from the product's label using hand-held computing device 34 or 35. Moreover, the consumer can scan the product barcode from a variety of sources or locations. For example, the consumer can scan the UPC code from a coupon or other similar document. Alternatively, the consumer can scan the UPC code from a product while at home, visiting a neighbor or at a restaurant. In addition to scanning the UPC, the consumer user can manually enter a product's bar code. GUI item 328 provides the consumer user with information on a list of products that are stored on hand-held computing device 34 or 35. In one embodiment, GUI item 328 is a pull-down list of products. Furthermore, when hand-held computing device 34 or 35 is not connected to communications network 47, the list of products can be stored on hand-held computing device in a product file stored in one of the storage areas on hand-held computing device 34 or 35.

GUI item 329 is a field where the user may enter the name of a product if the product number is unknown and the product is not in the product file. GUI item 336 represents the quantity of items that is currently on the shopping list. In one embodiment, the quantity of items can be modified using GUI item 336. Once the product has been entered into hand-held computing device 34 or 35, the user can either accept the product or delete the product from the shopping list. GUI item 334 allows the consumer user to save the information on the screen, clear the fields on the screen and add more items. GUI item 338 allows the consumer user to delete the item from the shopping list.

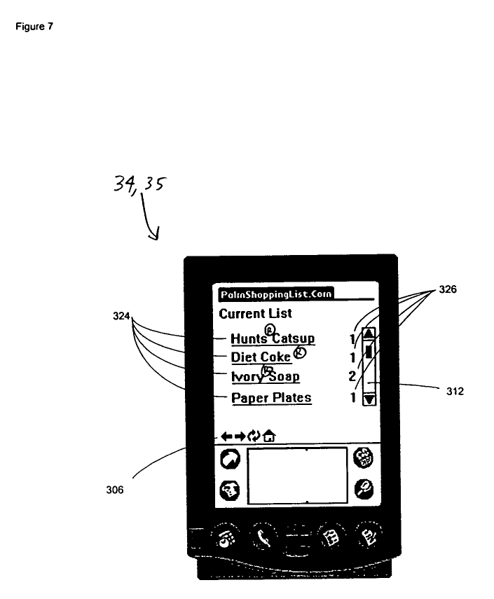

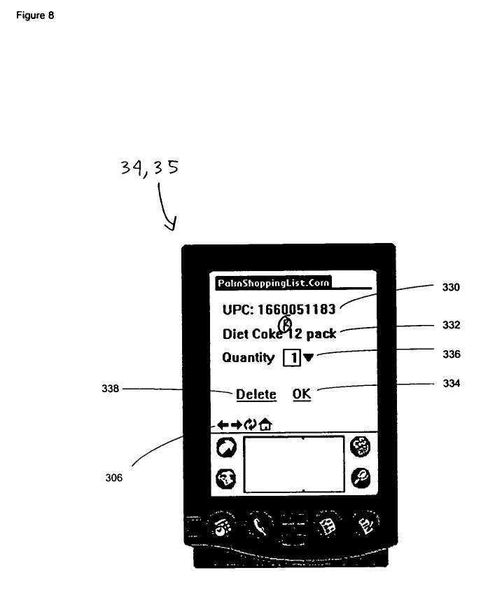

FIG. 7 is a sample screen shot showing a hand-held computing device 34 or 35 that would be used in a CLMS shopping list application allowing the consumer user to view and edit their shopping list. GUI items 324 represent products that are currently on the consumer's shopping list. By touching a product 324, the consumer can view more information on the product (See FIG. 8). For example, the consumer can view the product's UPC number or other product identification number, the product description, the product price, the location of the product in the retail store, and other information about the product such as contents, ingredients or nutritional data. Furthermore, a total amount for all of the products on the list can be displayed to the consumer.

FIG. 8 is a sample shopping list that can be printed in the retail store immediately prior to the consumer user beginning a shopping trip. GUI item 330 represents the product UPC or identification number. GUI item 332 is the description of the product. GUI item 336 represents the quantity of the products that are on the shopping list. In one embodiment, the quantity of items on the shopping list can also be modified using GUI item 335. GUI item 338 allows the consumer user to delete the product from the shopping list. GUI item 334 allows the consumer user to save the screen information, close the screen and return the user to the screen represented by FIG. 6.

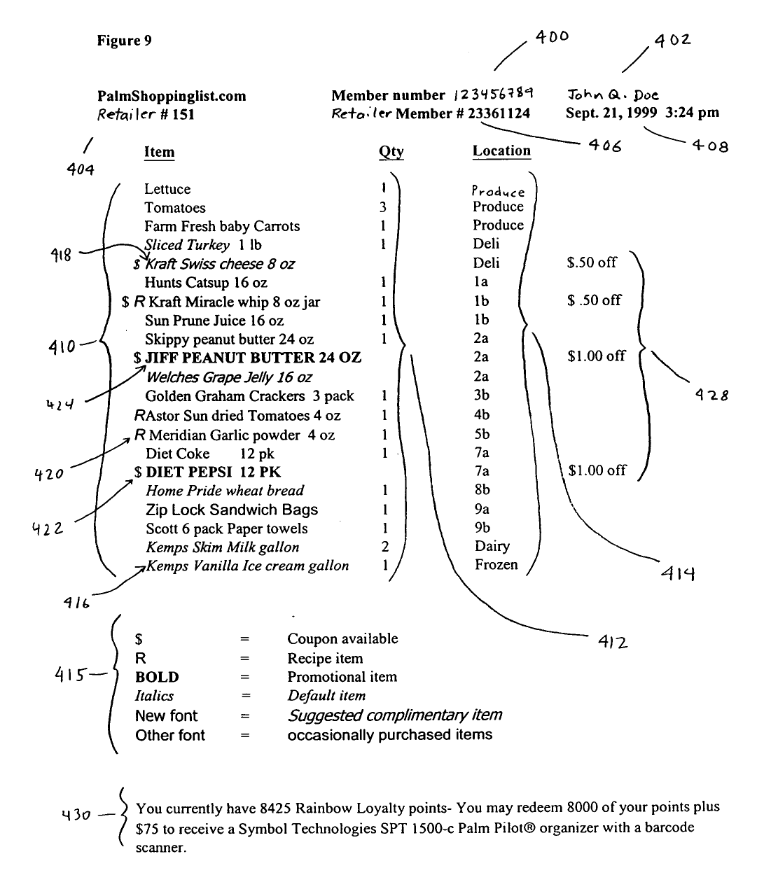

FIG. 9 is a sample shopping list that can be printed in the retail store immediately prior to the consumer user beginning a shopping trip. In one embodiment, the font type, character size, character color and any other visual characteristics of the printed items can be modified according to the preference of the user. GUI item 400 is the CLMS system identification number for the consumer user. GUI item 402 is the consumer user name. GUI item 404 is the name of the retail store where the consumer user is shopping. GUI item 406 is the loyalty number the user has with the retail store shown in GUI item 404. GUI item 408 shows the current date and time.

GUI items 410 represents the products the user has placed on the shopping list. GUI item 412 shows the quantity of each item on the shopping list. GUI item 414 represents the location within the store where the product can be found. The amount of detail in this field is dependant on the level of information provided by the retailer 404.

Legend 415 identifies the status for each of the products on the shopping list. For example, legend 415 indicates whether a coupon is available for the product, whether the product is a recipe product, a default product, suggested complimentary product, or an occasionally purchased product. Accordingly, product 416 is a default item meaning that it is a product the consumer user has chosen to be placed on the default shopping list for each shopping trip.

Product 418 is a product the CLMS system has suggested to the shopper. GUI item 420 indicates that the product is from a recipe list the user has chosen from the CLMS or a CLMS affiliated system. GUI item 422 indicates that a coupon is available for the product. Product 424 is a promotional item. GUI item 426 is an item that is occasionally purchased by the consumer and may need replenishing. GUI items 428 is the value of the promotional or coupon discounts for the applicable items. GUI item 430 is a promotional offer sent to the shopper that pertains to the retailers loyalty program.

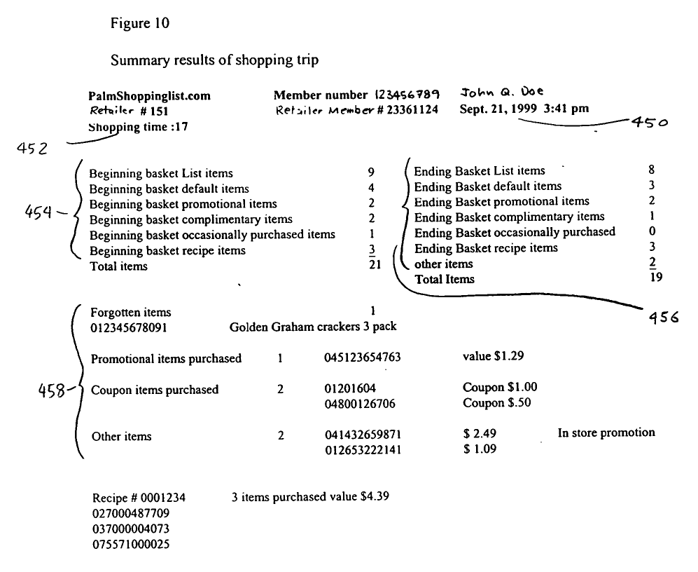

FIG. 10 shows the type of data that can be made available after a user has completed a shopping trip to measure the effectiveness of the marketing efforts directed to a particular shopper and/or shopping event. GUI item 450 is the time and day the shopping trip is completed. GUI item 452 is the elapsed time between the time the shopper initiated contact with the CLMS system for this shopping trip and the time the shopping trip was completed. GUI items 454 shows information relating to the beginning basket of products on the shoppers list such as beginning list items, default items, promotional items, complimentary items, occasionally purchased items or recipe items. GUI items 456 represent information related to the actual ending basket of products purchased by the shopper during this shopping trip such as ending list items, default items, promotional items, complimentary items, occasionally purchased items or recipe items.

GUI item 458 represents examples of the type of analysis the CLMS system can provide with respect to the shopping trip. Examples of the type of information that CLMS application can provide include, but are not limited to, information relating to items on the shopping list that were forgotten, promotional items purchased, or coupon items that were purchased. Similarly, the CLMS application can provide information about product features, specifications or reviews about the product from critics. Moreover, other third party software applications can be applied to the data generated by the shopping event and by the CLMS system to enhance the information provided.

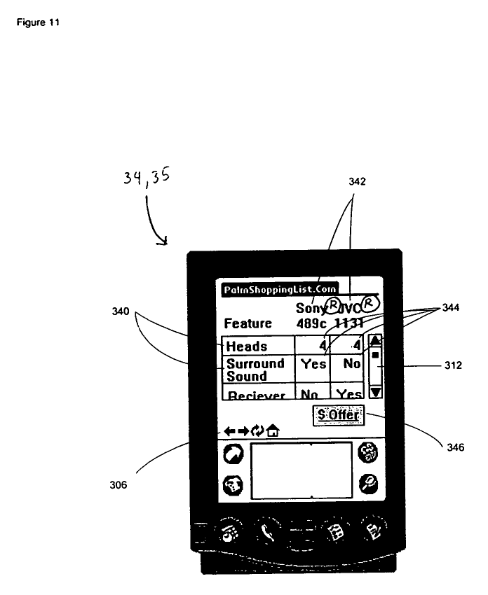

FIG. 11 is a sample screen shot showing a hand-held computing device 34 or 35 that would be used in a CLMS shopping list application showing an alternative embodiment of the application. For example, a retail store sales associate using a hand-held computing device 34 or 35 capable of wireless communication across a communications network can be connected to the network 47.

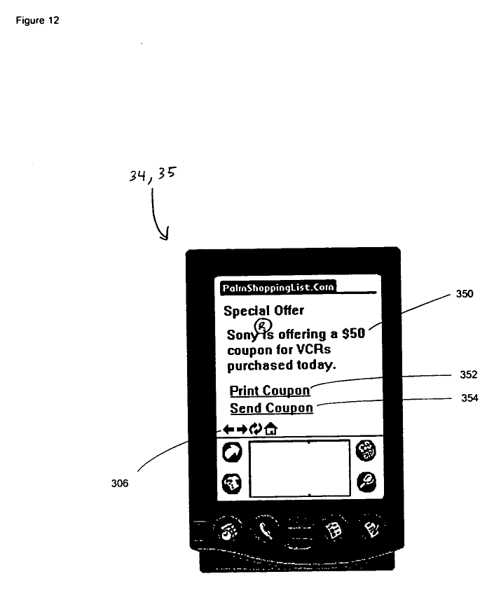

The retail associate would be able to perform a comparison of the features of two different products. In such a case, the CLMS server would be notified of the request to compare two specific products. The CLMS server can check supplier data 72 or pass the information to a supplier computing system 49 to determine if a supplier wants to offer a real time promotion to the customer. GUI item 342 represents the manufacturer and model numbers of the products being compared. GUI item 340 represents the features of the products. GUI item 344 represents the value, quantity or status of the features for each product. GUI item 346 indicates to the viewer that there is a special promotional offer available. The user can view the offer (See FIG. 12) by selecting GUI item 346. In an alternative embodiment, the CLMS does not have to be a comparison between two products but can be a description of the product including its features, specification or review by critics.

FIG. 12 is a sample screen shot showing a hand-held computing device 34 or 35 that would be used in a CLMS shopping list application showing the special promotional offer after the user has selected GUI item 346. FIG. 12 is available to either the consumer user or a retail associate. GUI item 350 represents the promotional offer. GUI item 352 allows the user (for example, the retail associate or the consumer user) to print the associated coupon or obtain a written copy of the offer. GUI items 352 and/or 354 can be accessed when the consumer user is at the point of sale register purchasing the products on the shopping list. Accordingly, GUI item 354 allows the consumer user to electronically transmit a copy of the offer to the retail store system using infrared, radio frequency or a physical electronic connection to the POS system or remote connection point.

FIG. 13 is a sample screen shot showing a hand-held computing device 34 or 35 that illustrates a promotional offer being made to the consumer. GUI item 360 represents the name of the promotional offer. GUI item 361 allows the user to get additional information that pertains to the offer. For example, if the promotional offer allows the user to redeem a coupon for a product from a predetermined list of products, GUI item 361 can allow the consumer to view the list of products available. GUI item 362 is the unique identifier associated with the promotional offer. As discussed above, the unique identifier can be used to indicate the authenticity of the promotional offer. Similarly, the unique identifier can be used to verify whether the promotional offer has been redeemed as well as to update the consumer, supplier and/or other promotional records. When redeeming a promotional offer, the user can communicate the unique identifier 362 to the retailer who can enter the unique identifier into the POS system or remote connection point 39 or this unique identifier can be communicated from the hand-held computing device 34 or 35 to the POS system or remote connection point.

It should be understood that the sample screen shots described above are not meant to be inclusive of all of the features of the CLMS application. In many cases, the user interface and CLMS application options on the hand-held computing device 34 or 35 can vary based on factors, which include but may not be limited to, the operating system and/or display 52 on hand-held computing device 34 or 35, the CLMS applications selected by the user as part of the CLMS application preferences, as well as the options offered by the vendors/suppliers that use CLMS application.

The various embodiments described above are provided by way of illustration only and should not be construed to limit the invention. Those skilled in the art will readily recognize the various modifications and changes which may be made to the present invention without strictly following the exemplary embodiments illustrated and described herein, and without departing from the true spirit and scope of the present invention, which is set forth in the following claims.

The claimed invention is:

1. A computing system for managing a shopping event at one or more retail locations, the system comprising:
(a) a hand-held computer configured to receive shopping list information from a user; the shopping list information defining a collection of products to be purchased during the shopping event;
(b) a server computing system operable with the hand-held computer; the server computing system being configured to receive the shopping list information from the hand-held computer; the server computing system further being configured to distribute one or more information packets associated with each of the products to the hand-held computer in advance of the shopping event; and
(c) a retailer computing system associated with each of the retail locations capable of communicating with the hand-held computer; the retailer computing system being configured to receive the shopping list information and the information packets associated with each of the products from the hand-held computer as the user completes the shopping event.

2. The computing system of claim 1, wherein the retailer computing system receives the shopping list information and the information packets associated with each of the products from the hand-held computer electronically.

3. The computing system of claim 1, wherein the information packets distributed from the server computing system includes a promotional offer redeemable at one of the retail locations.

4. The computing system of claim 3, wherein the promotional offer includes a unique identifier; wherein further the retailer computing system is further configured to measure the effectiveness of the promotional offer by verifying whether the promotional offer has been redeemed by the user.

5. The computing system of claim 1, wherein the retailer computing system is further configured to provide an alert to the user as the user completes the shopping event.

6. The computing system of claim 5, wherein the alert includes a list of one or more products included within the shopping list that were not purchased by the user.

7. The computing system of claim 1, wherein the information packets distributed from the server computing system are tailored to the needs of the user according to profile information relevant to the user.

8. The computing system of claim 1, wherein the server computing system is further configured to distribute a refined shopping list to the hand-held computer in advance of the shopping event.

9. The computing system of claim 8, wherein the refined shopping list is printed in advance of the shopping event.

10. The computing system of claim 8, wherein the refined shopping list includes products the user has previously purchased from the one or more retail locations.

11. The computing system of claim 1, wherein the user manually enters the shopping list information into the hand-held computer.

12. The computing system of claim 1, wherein the user enters the shopping list information into the hand-held computer using an optical scanner.

13. The computing system of claim 1, wherein the information packets distributed from the server computing system originate from the retail computing system.

14. The computing system of claim 1, wherein the information packets distributed from the server computing system originate from one or more supplier computing systems.

15. A method for managing a shopping event at one or more retail locations, the method comprising:
(a) generating a shopping list on a hand-held computer; the shopping list defining a collection of products to be purchased during the shopping event;
(b) providing the shopping list to a server computer system operable with the hand-held computer;
(c) receiving one or more information packets from the server computing system in advance of the shopping event; the one or more information packets being associated with each of the products; and
(c) distributing the shopping list and the information packets to a retailer computing system associated with the one or more retail locations.

16. The method of claim 15, wherein distributing the shopping list and the information packets to the retailer computing system includes distributing the shopping list and the information packets electronically.

17. The method of claim 15, wherein receiving one or more information packets from the server computing system includes receiving one or more promotional offers redeemable at one of the retail locations.

18. The method of claim 17, wherein the one or more promotional offers include a unique identifier; wherein the method further comprises measuring the effectiveness of the promotional offer by verifying whether the promotional offer has been redeemed by the user.

19. The method of claim 15, the method further comprising providing an alert as the user completes the shopping event.

20. The method of claim 19, wherein providing an alert as the user completes the shopping event includes providing an alert having a list of one or more products included within the shopping list that were not purchased by the user.

21. The method of claim 15, wherein receiving one or more information packets from the server computing system includes receiving information packets that are tailored to the needs of the user according to profile information relevant to the user.

22. The method of claim 15, the method further comprising receiving a refined shopping list from the server computing system in advance of the shopping event.

23. The method of claim 22, the method further comprising printing the refined shopping list in advance of the shopping event.

24. The method of claim 22, wherein receiving a refined shopping list from the server computing system includes receiving a shopping list having products the user has previously purchased from the one or more retail locations.

25. The method of claim 15, wherein generating the shopping list on the hand-held computer comprises manually entering the shopping list into the hand-held computer.

26. The method of claim 15, wherein generating the shopping list on the hand-held computer comprises entering the shopping list into the hand-held computer using an optical scanner.

27. The method of claim 15, wherein the information packets received from the server computing system originate from one or more retail computing systems.

28. The method of claim 15, wherein the information packets received from the server computing system originate from one or more supplier computing systems.
